(19) United States
(12) Patent Application Publication
(10) Pub. No.: US 2026/0045865 A1
(43) Pub. Date: Feb. 12, 2026

(54) NON-ISOLATED PUSH-PULL CONVERTER

(71) Applicant: LITE-ON TECHNOLOGY CORPORATION, TAIPEI CITY (TW)

(72) Inventors: Han-Min HUANG, Taipei City (TW); Cheng-Wei TSENG, Taipei City (TW); Yong-Long SYU, Taipei City (TW); Kai-De CHEN, Taipei City (TW); Chen CHEN, Taipei City (TW)

(21) Appl. No.: 19/260,833

(22) Filed: Jul. 7, 2025

Related U.S. Application Data
(60) Provisional application No. 63/681,957, filed on Aug. 12, 2024.

(30) Foreign Application Priority Data
May 19, 2025 (CN) 202510641389.6

(51) Int. Cl. H02M 1/00; H02M 3/337

(52) U.S. Cl. CPC H02M 1/0048; H02M 3/337

(57) ABSTRACT

A non-isolated push-pull converter is provided. The converter includes first and second primary side windings, first and second secondary side windings, and first and second feedback switches. The first primary side winding and a first switch are coupled between an input terminal and a first node. The second primary side winding and a second switch are coupled between the input terminal and a second node. The first secondary side winding is coupled between the first node and a third node. The second secondary side winding is coupled between the second and third nodes. The first feedback switch is coupled between the second node and a ground. The second feedback switch is coupled between the first node and the ground. The third node is coupled to an output terminal.

### CROSS REFERENCE TO RELATED APPLICATIONS

This application claims the benefit of U.S. Provisional Application No. 63/681,957, filed Aug. 12, 2024, the entirety of which is incorporated by reference herein.

This Application claims priority of China Patent Application No. 202510641389.6, filed on May 19, 2025, the entirety of which is incorporated by reference herein.

### BACKGROUND OF THE INVENTION

### Field of the Invention

The present invention relates to a voltage converter, and, in particular, it relates to a non-isolated push-pull converter capable of reducing the quantity and the loss of the components.

### Description of the Related Art

Voltage converters are often used in various types of circuits to perform voltage boosting or bucking, in order to achieve better performance. Conventional voltage converters are usually isolated converters. However, a higher turn ratio is required when the circuit requires a high conversion ratio. In this way, the copper loss would also be higher.

### BRIEF SUMMARY OF THE INVENTION

An embodiment of the present invention provides a non-isolated push-pull converter, including first and second primary side windings, first and second secondary side windings, and first and second feedback switches. The first primary side winding and a first switch are coupled between an input terminal and a first node. The second primary side winding and a second switch are coupled between the input terminal and a second node. The first secondary side winding is coupled between the first node and a third node. The second secondary side winding is coupled between the second and third nodes. The first feedback switch is coupled between the second node and a ground. The second feedback switch is coupled between the first node and the ground. The third node is coupled to an output terminal.

During a positive half-cycle, the first switch and the first feedback switch are turned on, the second switch and the second feedback switch are turned off. The first primary side winding receives an input current from the input terminal, and transmits the input current, through the first secondary side winding, to the output terminal. The second secondary side winding generates an induced current based on the input current, and transmits the induced current to the output terminal.

During a negative half-cycle, the second switch and the second feedback switch are turned on, the first switch and the first feedback switch are turned off. The second primary side winding receives the input current from the input terminal, and transmits the input current, through the second secondary side winding, to the output terminal. The first secondary side winding generates the induced current based on the input current, and transmits the induced current to the output terminal, through an output inductor.

According to embodiments of the present disclosure, the non-isolated push-pull converter further includes a magnetic core, which has first and second pillars. The first primary side winding is wound on the first pillar, forming a first primary side winding layer. The second primary side winding is wound on the first pillar, forming a second primary side winding layer. The first secondary side winding is wound on the second pillar, forming a first secondary side winding layer. The second secondary side winding is wound on the second pillar, forming a second secondary side winding layer.

The first primary side winding has a first number of turns. The second primary side winding has a second number of turns. The first secondary side winding has a third number of turns. The second secondary side winding has a fourth number of turns. In an embodiment, the first, second, third, and fourth numbers of turns are all equal. In another embodiment, the first number of turns is equal to the second number of turns, and the third number of turns is equal to the fourth number of turns.

### BRIEF DESCRIPTION OF THE DRAWINGS

The present invention can be more fully understood by reading the subsequent detailed description and examples with references made to the accompanying drawings, wherein:

FIG. 1 shows a circuit diagram illustrating a non-isolated push-pull converter in accordance with an embodiment of the present disclosure;

FIG. 2A shows a circuit diagram illustrating the non-isolated push-pull converter of FIG. 1 during a positive half-cycle;

FIG. 2B shows a schematic winding diagram of the non-isolated push-pull converter of FIG. 2A;

FIG. 3A shows a circuit diagram illustrating the non-isolated push-pull converter of FIG. 1 during a negative half-cycle; and

FIG. 3B shows a schematic winding diagram of the non-isolated push-pull converter of FIG. 3A.

### DETAILED DESCRIPTION OF THE INVENTION

The following description is made for the purpose of illustrating the general principles of the invention and should not be taken in a limiting sense. The scope of the invention is best determined by reference to the appended claims.

In the conventional transformer windings, the primary side winding and the secondary side winding are usually directly adjusted to meet a required current ratio. For example, when the input current and the output current have a required ratio of 1:3, the primary side winding and the secondary side winding are directly adjusted to a number of turns ratio of 3:1, and the induced current generated by the secondary side winding would directly be the output current. In addition, the voltage across the primary side circuit of the conventional push-pull converters is usually twice of the input voltage (e.g., the input voltage is 60V, and the voltage across the primary side would be 120V). However, this may cause the voltage across the primary side circuit to exceed the upper limit of the switching elements (e.g., the upper limits of voltage across the common switching elements are within 80-100V), further cause the switching elements to be damaged or the useful life of the switching elements to be reduced.

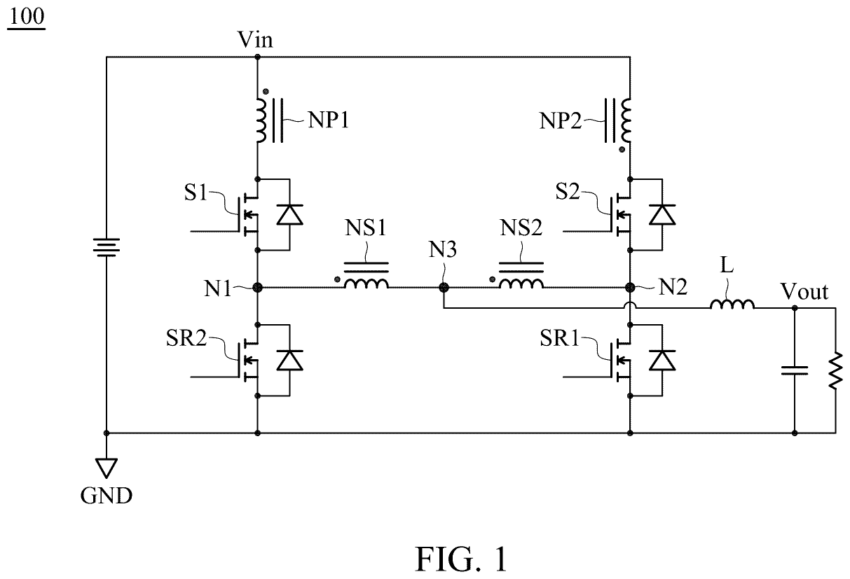

FIG. 1 shows a circuit diagram illustrating a non-isolated push-pull converter 100, in accordance with an embodiment of the present disclosure. The non-isolated push-pull converter 100 includes primary side windings NP1 and NP2, secondary side windings NS1 and NS2, switches S1 and S2, and feedback switches SR1 and SR2. The primary side winding NP1 and the switch S1 are coupled in series between an input terminal Vin and a node N1. The primary side winding NP2 and the switch S2 are coupled in series between the input terminal VIN and a node N2. The secondary side winding NS1 is coupled between the node N1 and a node N3. The secondary side winding NS2 is coupled between the nodes N2 and N3. The feedback switch SR1 is coupled between the node N2 and a ground GND. The feedback switch SR2 is coupled between the node N1 and the ground GND.

The non-isolated push-pull converter 100 further includes an output inductor L, coupled between the node N3 and an output terminal VOUT. The input terminal VIN is coupled to an input source (e.g., voltage supply), the output terminal VOUT is configured to output the current flowing through the output inductor L to a load circuit. In addition, the non-isolated push-pull converter 100 further includes an output load, including capacitors and resistors coupled between the ground GND and the output terminal VOUT. Furthermore, the feedback switches SR1, SR2 may be transistors, diodes, or other switching elements.

During a positive half-cycle of the non-isolated push-pull converter 100, the switch S1 and the feedback switch SR1 are turned on, and the switch S2 and the feedback switch SR2 are turned off, causing a current to flow from the input terminal VIN, through the primary side winding NP1, the switch S1, the secondary side winding NS1, and the output inductor L, to the output terminal VOUT. Meanwhile, because of the electromagnetic induction among the primary side winding NP1, and the secondary side windings NS1 and NS2, an induced current flows from the ground GND, through the feedback switch SR1, the secondary side winding NS2, and the output inductor L, to the output terminal VOUT. Therefore, the current flowing out from the output terminal VOUT has a current value of the current plus the induced current, causing the current flowing out from the output terminal VOUT to increase.

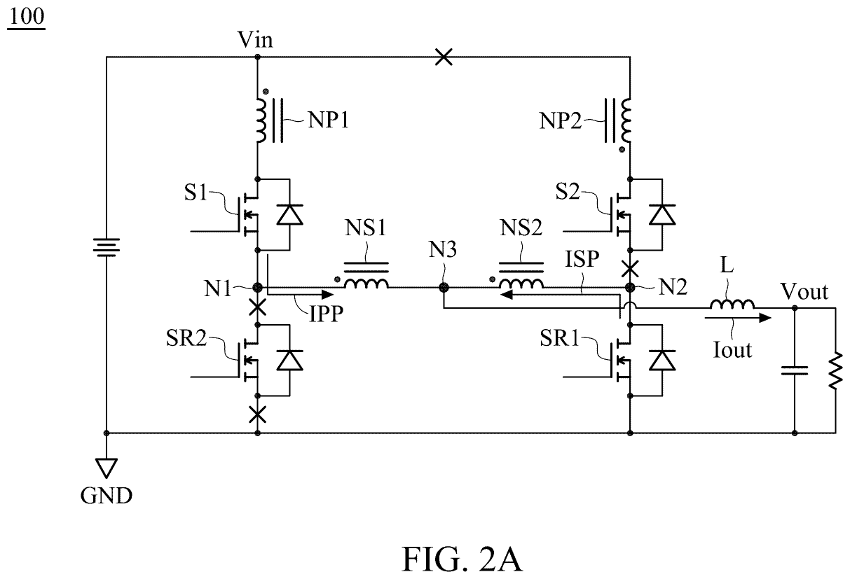

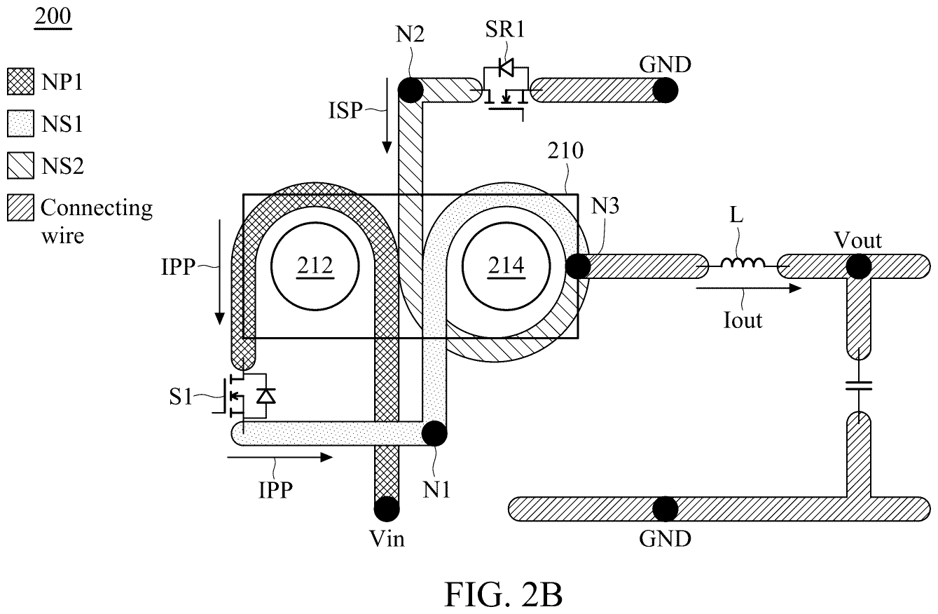

FIG. 2A shows a circuit diagram illustrating the non-isolated push-pull converter 100 of FIG. 1 during a positive half-cycle. As shown in FIG. 2A, since the switch S2 and the feedback switch SR2 are turned off during the positive half-cycle, the current would not flow toward the loops noted with “x” when flowing to the node N1 and N2. During the positive half-cycle, the switch S1 and the feedback switch SR1 are turned on. Thereby, a main current IPP (e.g., the input current) flows from the input terminal VIN, through the primary side winding NP1, the switch S1, the secondary side winding NS1, and the output inductor L, and flows out from the output terminal VOUT. Meanwhile, because of the electromagnetic induction among the primary side winding NP1, and the secondary side windings NS1 and NS2, an induced current ISP flows from the ground GND, through the feedback switch SR1, the secondary side winding NS2, and the output inductor L, and flows out from the output terminal VOUT. In other words, an output current Iout flowing out from the output terminal VOUT equals the sum of the main current IPP and the induced current ISP.

As shown in FIG. 2A, since the main current IPP flows through the primary side winding NP1 and the secondary side winding NS1, the total number of turns that the main current IPP flowing through could be regarded as the sum of the number of turns of the primary side winding NP1 (e.g., A turns) and the secondary side winding NS1 (e.g., B turns). Assume that the number of turns of the secondary side winding NS2 is C turns, the ratio of the current values of the main current IPP, the induced current ISP, and the output current Iout would be C:(A+B):(A+B+C). Therefore, by properly adjusting the number of turns ratio of the primary side winding NP1 and the secondary side windings NS1, NS2, the output current Iout would has a corresponding ratio.

FIG. 2B shows a schematic winding diagram 200, illustrating the non-isolated push-pull converter 100 of FIG. 2A. As shown in FIG. 2B, the non-isolated push-pull converter 100 further includes a magnetic core 210, which has magnetic pillars 212 and 214. The primary side windings NP1 and NP2 are wound on the magnetic pillar 212, forming two different primary side winding layers. The secondary side windings NS1 and NS2 are wound on the pillar 214, forming two different secondary side winding layers. The primary side winding NP2, the switch S2, and the feedback switch SR2 are not shown in FIG. 2B since the switch S2 and the feedback switch SR2 are turned off during the positive half-cycle.

Similar as shown in FIG. 2A, in FIG. 2B, the main current IPP flows from the input terminal VIN, through the primary side winding NP1 and the switch S1, to the node N1. Meanwhile, since the feedback switch SR2 is turned off, the main current IPP would flow toward the secondary side winding NS1, through the node N3 and the output inductor L, to the output terminal VOUT. In other words, during the positive half-cycle, the main current IPP flows in counterclockwise direction on the primary side winding NP1. Then, the main current IPP flows from the node N1, through the secondary side winding NS1, to the node N3, and flows through the output inductor L, to the output terminal VOUT. The main current IPP flows in clockwise direction on the secondary side winding NS1.

In response to the main current IPP, the induced current ISP flows from the ground GND, through the feedback switch SR1, to the node N2. Since the switch S2 is turned off during the positive half-cycle, the induced current ISP would flow toward the secondary side winding NS2, through the node N3 and the output inductor L, to the output terminal VOUT. Assume that the primary side winding NP1 and the secondary side windings NS1, NS2 have the same number of turns (1 turn as shown in FIG. 2B), then the number of turns that the main current IPP and the induced current ISP flowing through could be inferred as 2 turns and 1 turn, respectively. Therefore, the ratio of the main current IPP and the induced current ISP would be 1:2, and the ratio of the output current Iout and the main current IPP would be 3:1.

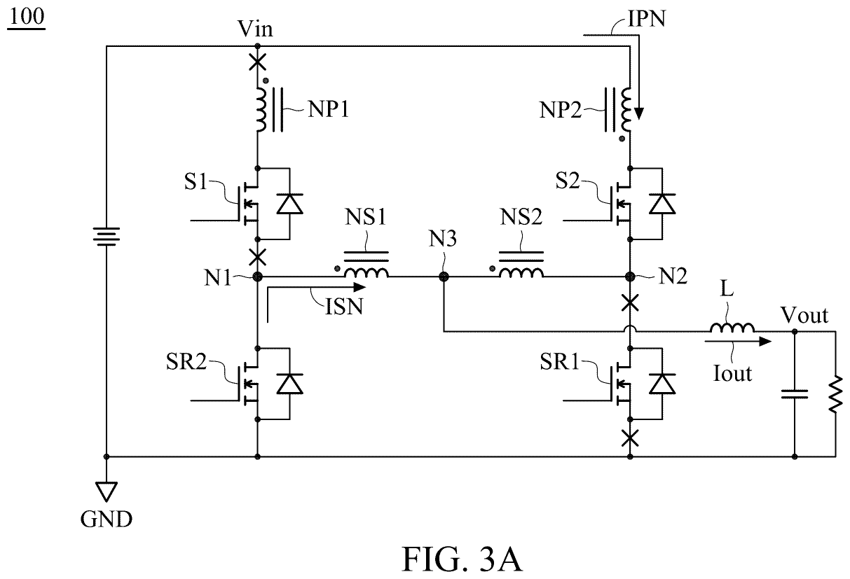

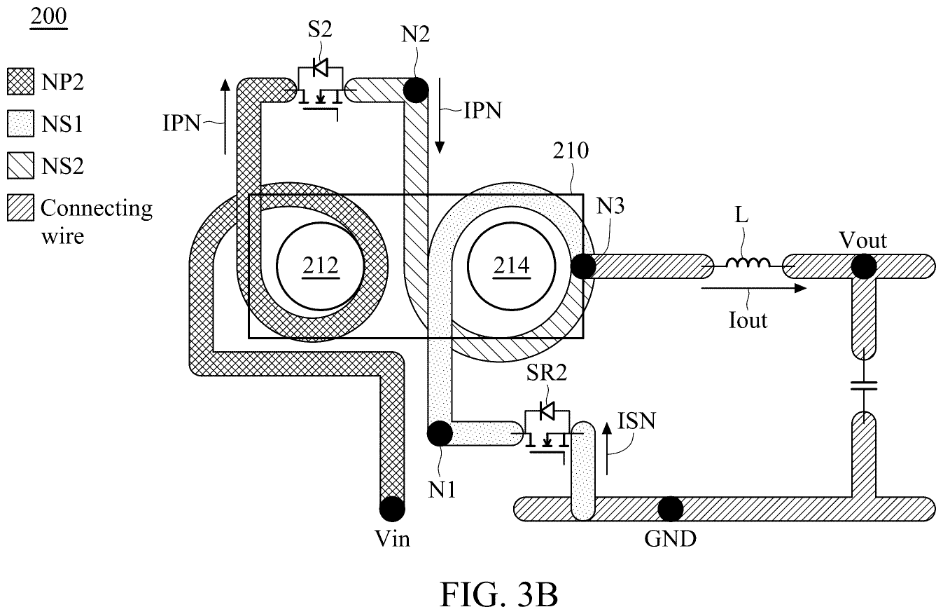

FIG. 3A shows a circuit diagram illustrating the non-isolated push-pull converter 100 of FIG. 1 during a negative half-cycle. Since the switch S1 and the feedback switch SR1 are turned off during the negative half-cycle, the current would not flow toward the loops noted with “x” when flowing to the node N1 and N2. During the negative half-cycle, the switch S2 and the feedback switch SR2 are turned on. Thereby, a main current IPN flows from the input terminal VIN, through the primary side winding NP2, the switch S2, the secondary side winding NS2, and the output inductor L, to the output terminal VOUT. Meanwhile, because of the electromagnetic induction among the primary side winding NP2, and the secondary side winding NS1 and NS2, an induced current ISN flows from the ground GND, through the feedback switch SR2, the secondary side winding NS1, and the output inductor L, and flows out from the output terminal VOUT. In other words, an output current Iout flowing out from the output terminal VOUT is the sum of the main current IPN and the induced current ISN.

As shown in FIG. 3A, since the main current IPN flows through the primary side winding NP2 and the secondary side winding NS2, the total number of turns that the main current IPN flowing through is the sum of the number of turns of the primary side winding NP2 (e.g., D turns) and the secondary side winding NS2 (e.g., C turns). Meanwhile, if the number of turns of the secondary side winding NS1 is B turns, the ratio of the current values of the main current IPN, the induced current ISN, and the output current Iout could be inferred as B:(C+D):(B+C+D). Therefore, by properly adjusting the number of turns ratio of the primary side winding NP2 and the secondary side windings NS1, NS2, the output current Iout would has a corresponding ratio.

FIG. 3B shows a schematic winding diagram 200, illustrating the non-isolated push-pull converter 100 of FIG. 3A. The primary side winding NP1, the switch S1, and the feedback switch SR1 are not shown in FIG. 3B since the switch S1 and the feedback switch SR1 are turned off during the negative half-cycle. Similar as shown in FIG. 3A, in FIG. 3B, the main current IPN flows from the input terminal VIN, through the primary side winding NP2 and the switch S2, to the node N2. Meanwhile, since the feedback switch SR1 is turned off, the main current IPN would flow toward the secondary side winding NS2, through the node N3 and the output inductor L, to the output terminal VOUT. In other words, during the negative half-cycle, the main current IPN flows in clockwise direction on the primary side winding NP2. Then, the main current IPN flows from the node N2, through the secondary side winding NS2, to the node N3, and flows through the output inductor L, to the output terminal VOUT. The main current IPN flows in counterclockwise direction on the secondary side winding NS2.

In response to the main current IPN, the induced current ISN flows from the ground GND, through the feedback switch SR2, to the node N1. Since the switch S1 is turned off during the negative half-cycle, the induced current ISN would flow toward the secondary side winding NS1, through the node N3 and the output inductor L, to the output terminal VOUT. Assume that the primary side winding NP2 and the secondary side windings NS1, NS2 have the same number of turns (1 turn as shown in FIG. 3B), then the number of turns that the main current IPN and the induced current ISN flowing through could be inferred as 2 turns and 1 turn, respectively. Therefore, the ratio of the main current IPN and the induced current ISN would be 1:2, and the ratio of the output current Iout and the main current IPN would be 3:1.

In an embodiment, the number of turns of the primary side windings NP1, NP2 are set to 2 turns, respectively. The number of turns of the secondary side windings NS1, NS2 are set to 1 turn, respectively. Thereby, during the positive half-cycle, the main current IPP on the primary side winding NP1 and the secondary side winding NS1 flows through 3 turns, and the induced current ISP on the secondary side winding NS2 flows through 1 turn, causing the ratio of the main current IPP, the induced current ISP, and the output current Iout to be 1:3:4. Therefore, during the positive half-cycle (e.g., the non-isolated push-pull converter 100 performs a voltage bucking operation), the main current IPP flowing through the secondary side winding NS1 is less than the induced current ISP flowing through the secondary side winding NS2.

During the negative half-cycle, the main current IPN on the primary side winding NP2 and the secondary side winding NS2 flows through 3 turns, and the induced current ISN on the secondary side winding NS1 flows through 1 turn, causing the ratio of the main current IPN, the induced current ISN, and the output current Iout to be 1:3:4. Therefore, during the negative half-cycle, the main current IPN flowing through the secondary side winding NS2 is less than the induced current ISN flowing through the secondary side winding NS1.

Similarly, in another embodiment, the number of turns of the primary side windings NP1, NP2 and the secondary side windings NS1, NS2 are all set to 1 turn. Thereby, during the positive half-cycle, the number of turns that the main current IPP and the induced current ISP flow through are 2 turns and 1 turn, respectively, thereby causing the ratio of the current values to be 1:2. During the negative half-cycle, the number of turns that the main current IPN and the induced current ISN flow through are 2 turns and 1 turn, respectively, thereby causing the ratio of the current values to be 1:2. Therefore, similar to the embodiment where the number of turns of the primary side windings NP1, NP2 and the secondary side windings NS1, NS2 are respectively set to 2 turns and 1 turn, the main current IPP flowing through the secondary side winding NS1 is less than the induced current ISP flowing through the secondary side winding NS2 during the positive half-cycle, and the main current IPN flowing through the secondary side winding NS2 is less than the induced current ISN flowing through the secondary side winding NS1 during the negative half-cycle.

Through the structure of the non-isolated push-pull converter provided by embodiments of the present disclosure, the ratio of the input current and the output current may be 1:3, when the primary side windings and the secondary side windings have the same number of turns ratio. Then the purpose of reducing the winding loss (e.g., copper loss) is achieved. Meanwhile, the circuit connecting structure provided by the present disclosure may reduce the voltage across the primary side circuit of the push-pull converter (e.g., reduce to 1.33 times the input voltage), while having less switches than the conventional full-bridge converters or resonant converters. Thereby the purposes of increasing the power density and reducing the cost are achieved.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A non-isolated push-pull converter, comprising:
a first primary side winding, wherein the first primary side winding and a first switch are coupled between an input terminal and a first node;
a second primary side winding, wherein the second primary side winding and a second switch are coupled between the input terminal and a second node;
a first secondary side winding, coupled between the first node and a third node;
a second secondary side winding, coupled between the second node and the third node;
a first feedback switch, coupled between the second node and a ground; and
a second feedback switch, coupled between the first node and the ground,
wherein, the third node is coupled to an output terminal.

2. The non-isolated push-pull converter as claimed in claim 1, wherein during a positive half-cycle:
the first switch and the first feedback switch are turned on, the second switch and the second feedback switch are turned off;
the first primary side winding receives an input current from the input terminal, and transmits the input current through the first secondary side winding to the output terminal; and
the second secondary side winding generates an induced current based on the input current, and transmits the induced current to the output terminal.

3. The non-isolated push-pull converter as claimed in claim 1, wherein during a negative half-cycle:
the second switch and the second feedback switch are turned on, and the first switch and the first feedback switch are turned off;
the second primary side winding receives an input current from the input terminal, and transmits the input current through the second secondary side winding to the output terminal; and
the first secondary side winding generates an induced current based on the input current, and transmits the induced current to the output terminal.

4. The non-isolated push-pull converter as claimed in claim 1, further comprising an output inductor, coupled between the third node and the output terminal.

5. The non-isolated push-pull converter as claimed in claim 1, wherein a current flowing through the first primary side winding and a current flowing through the second primary side winding flow in opposite directions, when the first primary side winding and the second primary side winding receive the respective currents.

6. The non-isolated push-pull converter as claimed in claim 1, wherein a current flowing through the first secondary side winding and a current flowing through the second secondary side winding flow in opposite directions, when the first secondary side winding and the second secondary side winding receive the respective currents.

7. The non-isolated push-pull converter as claimed in claim 1, further comprising a magnetic core, having a first pillar and a second pillar, wherein:
the first primary side winding is wound on the first pillar, to form a first primary side winding layer;
the second primary side winding is wound on the first pillar, to form a second primary side winding layer;
the first secondary side winding is wound on the second pillar, to form a first secondary side winding layer;
the second secondary side winding is wound on the second pillar, to form a second secondary side winding layer;

8. The non-isolated push-pull converter as claimed in claim 7, wherein:
during a positive half-cycle, the first primary side winding layer and the first secondary side winding layer are connected in series, through the first switch, and the second secondary side winding layer generates an induced current; and
during a negative half-cycle, the second primary side winding layer and the second secondary side winding layer are connected in series, through the second switch, and the first secondary side winding layer generates the induced current.

9. The non-isolated push-pull converter as claimed in claim 8, wherein:
the first primary side winding has a first number of turns, the second primary side winding has a second number of turns, the first secondary side winding has a third number of turns, the second secondary side winding has a fourth number of turns;
a sum of the first number of turns and the third number of turns is equal to a first counting number, a sum of the second number of turns and the fourth number of turns is equal to a second counting number;
during the positive half-cycle, the first primary side winding receives an input current, and a ratio of the input current and the induced current is a ratio of the fourth number of turns and the first counting number; and
during the negative half-cycle, the second primary side winding receives the input current, and the ratio of the input current and the induced current is a ratio of the third number of turns and the second counting number.

10. The non-isolated push-pull converter as claimed in claim 9, wherein:
during the positive half-cycle, a current flowing through the first secondary side winding is less than a current flowing through the second secondary side winding; and
during the negative half-cycle, the current flowing through the first secondary side winding is larger than the current flowing through the second secondary side winding.

11. The non-isolated push-pull converter as claimed in claim 9, wherein the first number of turns, the second number of turns, the third number of turns, and the fourth number of turns are all equal.

12. The non-isolated push-pull converter as claimed in claim 9, wherein the first number of turns is equal to the second number of turns, and the third number of turns is equal to the fourth number of turns.
